(19) United States
(12) Patent Application Publication
(10) Pub. No.: US 2009/0010259 A1
(43) Pub. Date: Jan. 8, 2009

(54) DEVICE, SYSTEM, AND METHOD OF CLASSIFICATION OF COMMUNICATION TRAFFIC

(76) Inventor: Alexander Sirotkin, Tel-Aviv (IL)

Correspondence Address: EMPK & Shiloh, LLP;c/o Landon IP, Inc., 1700 Diagonal Road, Suite 450, Alexandria, VA, 22314, US

(21) Appl. No.: 11/774,600

(22) Filed: Jul. 8, 2007

(51) Int. Cl. H04L 12/28

(52) U.S. Cl. 370/392

(57) ABSTRACT

Device, system, and method of classification of communication traffic. For example, a communication traffic classifier includes: a dynamically configurable port and address classifier to classify an unclassified packet based on port and address configuration information received from an application protocol classifier.

### FIELD

Some embodiments of the invention are related generally to the field of communication, and more particularly to the field of classification of communication traffic.

### BACKGROUND

A wired or wireless communication system may include a transmitting unit able to transmit packetized data (e.g., packets or flames) to one or more receiving units, directly or through one or more routing units. The communication system may provide different levels of Quality of Service (QoS) based on classification of the content carried by the transmitted data. For example, the communication system may allocate a high priority level to data streams that carry audio/video data, and may allocate a low priority level to data streams that carry Internet browsing data.

Some communication standards and protocols (e.g., the Internet Engineering Task Force (IETF) Differentiated Services), the IEEE 802.11 standard, the Digital Living Network Alliance (DLNA), and other standards and protocols) utilize a Differentiated Service Code Point (DSCP) field (e.g., occupying six bits in the Type of Service (ToS) Internet Protocol (IP) header) for traffic classification.

According to Differentiated Services (DifServ) architecture, the burden of traffic classification, namely, assignment of DSCP values to packets, lies on the application that generates the traffic. Unfortunately, some traffic-generating applications (e.g., streaming video applications) do not assign DSPC values to generated packets. Furthermore, the receiving device or the routing device is dependent, for classification purposes, on the traffic-generating application which may not be controlled or modified by the receiving or routing device.

According to IEEE 802.1Q standard, a User Priority field (e.g., occupying three bits) of the Virtual LAN (VLAN) header may be used to carry classification information. Unfortunately, VLAN tags and priorities associated therewith are manually created by a network administrator, and are rarely used by non-professional home users that utilize a residential communication network. Furthermore, the VLAN classification scheme is a Layer 2 classification, which can be used only in a “flat” communication network, namely, a communication network that does not include intermediary routing units.

A static port and address classifier performs classification based on analysis of address values and port values of the transmission source or the transmission destination. Unfortunately, the static port and address classifier requires manual configuration of port and address values, which may be dynamically assigned (ergo, using Dynamic Host Configuration Protocol (DHCP) or some dynamic port assignment schemes) and cannot be pre-defined. Furthermore, some audio/video streams may not be correctly classified using a static port and address classifier, for example, audio/video streams that are tunneled through Hypertext Transfer Protocol (HTTP) which utilizes port 80 that is shared with other applications.

According to some IEEE 802.11 wireless communication protocols, a Traffic Classifier (TCLAS) information element may be included in an Add Traffic Stream (ADDTS) frame sent by a wireless communication station, instructing a wireless Access Point (AP) how to classify downlink packets. Unfortunately, many Wireless LAN (WLAN) devices do not support TCLAS classification. Furthermore, TCLAS classification utilizes one or more of the classification methods described above to determine classification information to be transferred in the ADDTS flame, and thus suffers from their respective disadvantages.

An application protocol classifier may analyze the application layer packets in order to determine payload type for each packet, namely, to determine whether each packet is a video packet, a voice packet, a data packet, or the like. Unfortunately, an application protocol classifier which analyzes each packet may consume significant processing resources.

In some communication systems, an efficient implementation of a classifier may be required in order to provide a desired level of QoS. Unfortunately, in some communication systems, the traffic-generating application cannot be modified in order to deploy Diffserv classification or TCLAS classification, and significant processing resources (e.g., a high-end host processor) may not be available to efficiently perform an application protocol classification.

### SUMMARY

Some embodiments of the invention include, for example, devices, systems and methods of classification of communication traffic.

Some embodiments include, for example, a communication traffic classifier including: a dynamically configurable port and address classifier to classify an unclassified packet based on port and address configuration information received from an application protocol classifier.

In some embodiments, the communication traffic classifier includes the application protocol classifier, wherein the application protocol classifier is to generate the port and address information based on an application layer pattern analysis of one or more other unclassified packets.

In some embodiments, the communication traffic classifier includes a flow detector to receive the unclassified packet, to send the unclassified packet to the dynamically configurable port and address classifier if the unclassified packet belongs to a previously-classified communication flow, and to send the unclassified packet to the application protocol classifier if the unclassified packet belongs to a unclassified communication flow.

In some embodiments, the flow detector is to determine that a communication flow belongs to either: a group of one or more previously-classified communication flows; or a group of one or more active communication flows that include packets intended for classification by the application protocol classifier.

In some embodiments, the flow detector is to add a candidate communication flow to the group of one or more active communication flows if the number of packets in a candidate communication flow is larger than a value of a pre-defined threshold parameter.

In some embodiments, the pre-defined threshold parameter has a first value with respect to UDP communication, and a second, larger, value with respect to TCP communication.

In some embodiments, the application protocol classifier is to determine whether or not there exists a match between packets belonging to an unclassified communication flow, and a pre-defined pattern of application level protocol.

In some embodiments, if the application protocol classifier determines that the match exists, then the application protocol classifier is to move the unclassified communication flow from a database of unclassified communication flows to a database of classified communication flows.

In some embodiments, the application protocol classifier is to classify the unclassified packet based on an analysis of a header of at least one more unclassified packet.

In some embodiments, the application protocol classifier is to determine whether the unclassified packet is a Real-time Transport Protocol (RTP) packet by taking into account at least a protocol version parameter, a payload type parameter, a sequence number parameter, and a timestamp parameter.

In some embodiments, the application protocol classifier is to determine whether the unclassified packet is a MPEG Transport Stream (TS) packet by taking into account at least a value of a synchronization parameter and a value of a continuity parameter.

In some embodiments, the application protocol classifier is to determine whether the unclassified packet is a Microsoft Media Server (MMS) packet by taking into account at least a value of a sequence number field and a value of a packet ID) field.

In some embodiments, if the packet is a UDP packet, the application protocol classifier further takes into account at least a value of a flags field and a value of a length field.

In some embodiments, the dynamically configurable port and address classifier runs in a first thread, and the application protocol classifier runs in a second, lower-priority, thread.

In some embodiments, the communication traffic classifier is included in a mobile computer, a desktop computer, a wireless access point, a router, or a set-top box.

In some embodiments, a method of classifying communication traffic includes: classifying an unclassified packet based on port and address configuration information received by a dynamically configurable port and address classifier from an application protocol classifier.

In some embodiments, the method includes generating the port and address information based on an application layer pattern analysis of one or more other unclassified packets.

In some embodiments, the method includes sending the unclassified packet to the dynamically configurable port and address classifier if the unclassified packet belongs to a previously-classified communication flow, and sending the unclassified packet to the application protocol classifier if the unclassified packet belongs to an unclassified communication flow.

In some embodiments, the method includes determining that a communication flow belongs to either: a group of one or more previously-classified communication flows; or a group of one or more active communication flows that include packets intended for classification by the application protocol classifier.

In some embodiments, the method includes adding a candidate communication flow to the group of one or more active communication flows if the number of packets in a candidate communication flow is larger than a value of a pre-defined threshold parameter.

In some embodiments, the pre-defined threshold parameter has a first value with respect to UDP communication, and a second, larger, value with respect to TCP communication.

In some embodiments, the method includes determining whether or not there exists a match between packets belonging to an unclassified communication flow, and a pre-defined pattern of application level protocol.

In some embodiments, if it is determined that the match exists, the method includes moving the unclassified communication flow from a database of unclassified communication flows to a database of classified communication flows.

In some embodiments, the method includes classifying the unclassified packet based on an analysis of a header of at least one more unclassified packet.

In some embodiments, the method includes determining whether the unclassified packet is a Real-time Transport Protocol (RTP) packet by taking into account at least a protocol version parameter, a payload type parameter, a sequence number parameter, and a timestamp parameter.

In some embodiments, the method includes determining whether the unclassified packet is a MPEG Transport Stream (TS) packet by taking into account at least a value of a synchronization parameter and a value of a continuity parameter.

In some embodiments, the method includes determining whether the unclassified packet is a Microsoft Media Server (MMS) packet by taking into account at least a value of a sequence number field and a value of a packet ID field.

In some embodiments, the method includes: if the packet is a UDP packet, further taking into account at least a value of a flags field and a value of a length field.

In some embodiments, the method includes: running the dynamically configurable port and address classifier in a first thread; and running the application protocol classifier in a second, lower-priority, thread.

Some embodiments may include, for example, a computer program product including a computer-useable medium including a computer-readable program, wherein the computer-readable program when executed on a computer causes the computer to perform methods in accordance with some embodiments of the invention.

Some embodiments of the invention may provide other and/or additional benefits and/or advantages.

### BRIEF DESCRIPTION OF TIME DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system able to perform classification of communication traffic in accordance with a demonstrative embodiment of the invention; and

FIG. 2 is a schematic flow-chart of a method of classification of communication traffic in accordance with a demonstrative embodiment of the invention.

### DETAILED DESCRIPTION

In the following detailed description, numerous specific details are set forth in order to provide a thorough understanding of some embodiments of the invention. However, it will be understood by persons of ordinary skill in the art that embodiments of the invention may be practiced without these specific details. In other instances, well-known methods, procedures, components, units and/or circuits have not been described in detail so as not to obscure the discussion.

The terms “processing,” “computing,” “calculating,” “determining,” “establishing”, “analyzing”, “checking”, “estimating”, or similar terms, as used herein, refer to one or more operations and/or processes of a computer; a computing device, a computing platform, a computing system, or other electronic device or machine, that manipulate and/or transform data represented as physical quantities (e.g., electronic quantities) within a storage medium (e.g., registers, memory units, storage units, or the like) into other data similarly represented as physical quantities within the storage medium.

The terms “plurality” and “a plurality” as used herein may include, for example, “multiple” or “two or more” For example, “a plurality of items” includes two or more items.

Although portions of the discussion herein may relate, for demonstrative purposes, to wired links and/or wired communications, embodiments of the invention are not limited in this regard, and may include one or more wired or wireless links, may utilize one or more components of wireless communication, may utilize one or more methods or protocols of wireless communication, or the like. Some embodiments of the invention may utilize wired communication and/or wireless communication.

The terms “video” or “audio/video” as used herein may include, for example, information or content representing both audio and video, information or content representing only video and substantially no audio, information or content representing video and additional information elements (e.g., subtitles or captions) or control elements, information or content representing multiple video tracks, information or content representing one or more video tracks and optionally one or more video tracks, or the like.

The terms “video stream” or “video traffic” or “video content” as used herein may include, for example, one or more signals, blocks, frames, transmission streams, information items, packets, packages, files and/or messages that contain, carry and/or represent video content, audio/video content, motion picture content, a sequence of still images representing motion, one or more video clips or audio/video clips, compressed audio/video, lossy audio/video, uncompressed or “raw” or lossless audio/video, audio/video encoded using an audio encoder and/or a video encoder, audio/video requiring one or more or coders/decoders (codecs) for playback or presentation, or the like.

The terms “non-video stream” or “non-video traffic” or “non-video content” or “non-audio/video stream” or “non-audio/video traffic” or “non-audio/video content” as used herein may include, for example.

Some embodiments may be used to classify various types of audio/video traffic, for example, Moving Picture Experts Group (MPEG) audio/video, MPEG-1 audio/video, MPEG-2 audio/video, MPEG-4 audio/video, MPEG-4 Part-10 Advanced Video Coding (AVC) audio/video, MPEG-4 Part-2 Advanced Simple Profile (ASP) audio/video, Motion Joint Photographic Experts Group (M-JPEG) audio/video, H.261 audio/video, H.263 audio/video, H.264 audio/video, DivX audio/video, Xvid audio/video, 3ivx audio/video, Nero Digital audio/video, Windows Media Video (WMV) audio/video, Advanced Systems Format (ASF) audio/video, Society of Motion Picture and Television Engineers (SMPTE) VC-1 audio/video, QuickTime audio/video, RealVideo or RealMedia audio/video, Ogg Theora audio/video, Indeo audio/video, Matroska audio/video, Microsoft Media Server (MMS) audio/video, MMS over UDP audio/video, MMS over TCP audio/video, Real Time Stream Protocol (RTSP) audio/video, Real-time Transport Protocol (RTP) audio/video, streaming audio/video, broadcast audio/video, multicast audio/video, unicast audio/video, or the like.

Some embodiments may be used to classify audio/video traffic which may be in accordance with one or more audio/video standards, for example, “Request For Comments (RFC) 3550—RTP: A Transport Protocol for Real-Time Applications”; “RFC 2326—Real Time Streaming Protocol (RTSP)”; “RFC 3551—RTP Profile for Audio and Video Conferences with Minimal Control”; “RFC 2250—RTP Payload Format for MPEG1/MPEG2 Video”; “RFC 2474—Definition of the Differentiated Services Field (DS Field) in the IPv4 and IPv6 Headers”; “RFC 2475—Architecture for Differentiated Services”; or the like.

Some embodiments of the invention may be used in a variety of applications. Some embodiments may be used in conjunction with various devices and systems, for example, a Personal computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a display unit, a monitor, a screen, a projector, a Cathode Ray Tube (CRT) screen or monitor, a Liquid Crystal Display (LCD) screen or monitor, a plasma screen or monitor, a touch screen, a projector device, a set-top box, a wireless communication station, a wireless communication device, a wireless Access Point (AP), a modem, a network, a wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a wireless PAN (WPAN), devices and/or networks operating in accordance with existing IEEE 802.11, 802.11a, 802.11b, 802.11e, 802.11g, 802.11h, 802.11i, 802.11n, 802.16, 802.16d, 802.16e standards and/or future versions and/or derivatives and/or Long Term Evolution (LTE) of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, or the like.

Some embodiments of the invention may be used in conjunction with one or, more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), Global Positioning System (GPS), Wi-Fi, Wi-Max, ZigBee™, Global System for Mobile communication (GSM), 2G, 2.5G, 3G, 3.5G, or the liken Embodiments of the invention may be used in various other devices, systems and/or networks.

Although portions of the discussion herein relate, for demonstrative purposes, to classification of video or audio or audio/video, embodiments of the invention are not limited in this regard, and may be used for classification of various other application level protocols.

At an overview, some embodiments of the invention provide a classification method able to differentiate between video and data, or between video and non-video, or between high-priority traffic and low-priority traffic where priority depends on the content of the data packet. In some embodiments, the classification method is independent of external applications for classification, and does not require complex configuration. In some embodiments, the classification method operates with complexity smaller than O(n), where n represents packet length.

In some embodiments, an autonomous classifier is a two-tier classifier which combines the advantages associated with an application protocol classifier and the advantages associated with a port and address classifier; substantially without the disadvantages associated with each of these classifiers when operating by itself. In some embodiments, the autonomous classifier allows the application protocol classifier to operate substantially exclusively on pre-identified video protocols, thereby reducing consumption of processing resources.

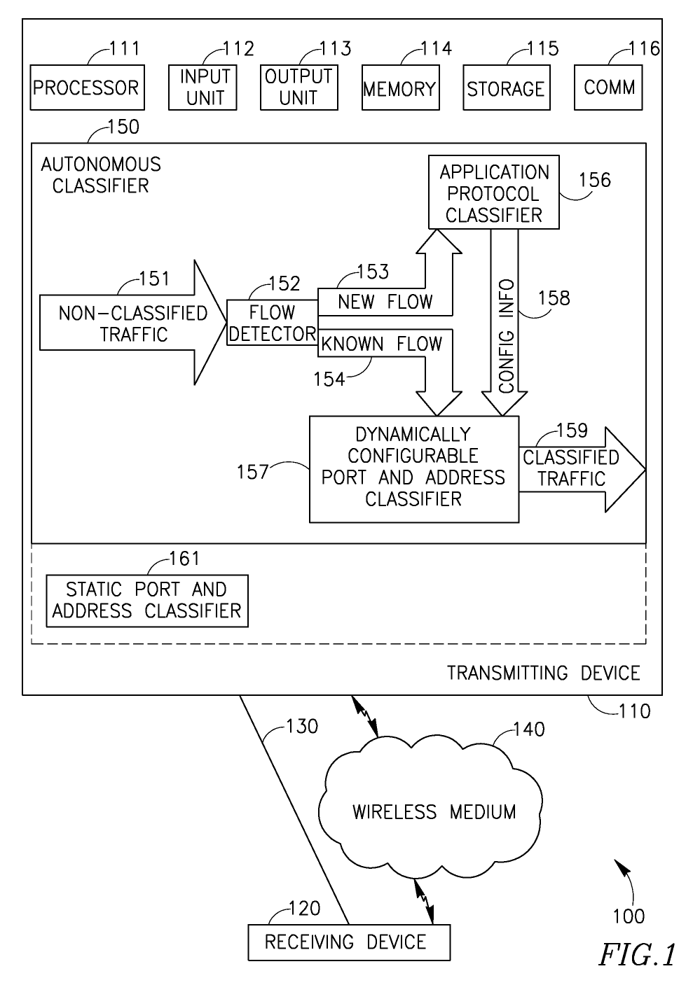

FIG. 1 schematically illustrates a block diagram of a system 100 able to perform classification of communication traffic in accordance with some demonstrative embodiments of the invention. System 100 may be or may include, for example, a wired or wireless communication system or network System 100 may include, for example, a transmitting device 110 able to transmit signals to a receiving device 120, directly or indirectly, eggs, through a wired link 130 or a wireless link utilizing a wireless medium 140.

The transmitting device 110 may be or may include, for example, a computing device, a computer, a Personal Computer (PC), a server computer, a client/server system, a mobile computer, a portable computer, a laptop computer, a notebook computer, a tablet computer, a network of multiple inter-connected devices, a router, a switch, a hub, a bridge, a wired or wireless media center, a wired or wireless multimedia center, an audio/video source, an audio/video content provider or content server, an audio/video signal generator or router, a DVD player, a satellite dish or associated device, a set-top box, or the like.

The receiving device 120 may be or may include, for example, a wired or wireless display unit, a wired or wireless monitor, a wired or wireless screen, a projector, a Cathode Ray Tube (CRT) screen or monitor, a Liquid Crystal Display (LCD) screen or monitor, a plasma screen or monitor, a touch screen, a projector or other projection device, a set-top box, a cable box, wired or wireless speakers, wired or wireless stereo system, a media or multimedia adapter, a media or multimedia receiver, a television, a High Definition Television (HDTV) screen, or the like.

Optionally, the transmitting device 110 may include, for example, a processor, 111 an input unit 112 (e.g., a keyboard, a mouse, or the like), an output unit 113 (e.g., a screen, speakers, or the like), a memory unit 114, a storage unit 115, a communication unit 116 (e.g., a Network Interface Card (WIC), a wired or wireless modem, a wired or wireless transceiver having one or more antennas, or the like), and other suitable hardware components and/or software components, which may be enclosed in a common housing.

The transmitting device 110 includes an autonomous classifier 150 able to classify outgoing traffic, e.g., outgoing packets, packets originating from the transmitting device 110, packets routed by the transmitting device 110 (e.g., operating as an intermediary communication device), or the like. For example, the autonomous classifier 150 may classify one or more outgoing packets as video packets or non-video packets, or as audio/video packets or non-audio/video packets. Additionally or alternatively, the autonomous classifier 150 may classify one or more outgoing packets in accordance with classes and/or sub-classes, for example, as a video packet having RTP format, as an MPEG Transport Stream (TS) packet, as an MMS packet, or the like Optionally, the autonomous classifier 150 may add, set, reset or modify packet fields or packet bits (e.g., header fields or header bits) that indicate classification information, QoS information, priority information, or the like.

The autonomous classifier 150 is a multiple tier classifier, for example, a two-tier classifier, A first tier of the autonomous classifier 150 utilizes an application protocol classifier 156, and a second tier of the autonomous classifier 150 utilizes a dynamically configurable port and address classifier 157. The autonomous classifier 150 may combine the advantages of the application protocol classifier 156 with the advantages of the dynamically configurable port and address classifier 157, while eliminating possible disadvantages of each of them if utilized by itself. For example, output generated by the application protocol classifier 156 (e.g., classification information or classification results) is transferred to the dynamically configurable port and address classifier 157 as configuration information 158, e.g., as port and address configuration information which may be utilized by the dynamically configurable port and address classifier 157. In some embodiments, the application protocol classifier 156 operates selectively, or substantially exclusively, on packets or streams associated with one or more application level protocols, thereby reducing resources consumption (e.g., processing overhead).

In some embodiments, non-classified traffic 151 (e.g., non-classified or unclassified packets) passes through a flow detector 152 which detects one or more flows. Traffic that belongs to a known flow 154 (e.g., an existing flow that was already identified by the flow detector 152 and for which the port, the address and other parameters were already extracted) passes through the dynamically configurable port and address classifier 157. Traffic that belongs to a new flow 153 (e.g., a flow that was not already identified by the flow detector 152 and that packets thereof were not yet classified) passes through the application protocol classifier 156, whose output is used as configuration information 158 for the dynamically configurable port and address classifier 157, which in turn outputs classified traffic 159.

The autonomous classifier 150 utilizes a classification algorithm which operates, for example, with TCP communication, with IP communication, with TCP/IP communication, with HTTP communication, and/or with UDP communication. In some embodiments, TCP processing may consume more processing resources, and TCP may not be frequently used for audio/video deliver; thus, in some implementations of the autonomous classifier 150, TCP processing may be optional.

The application protocol classifier 156 and/or the classification algorithm used by the autonomous classifier 150 may support and/or identify multiple video-related application protocols, for example: RTP; VideoLAN Raw UDP; MMS over UDP (MMSU); MMS over TCP (MMST); MMS over HTTP (MMSH). Other protocols and/or additional protocols may be supported and/or identified. In some embodiments, a relatively low number of supported protocols may be used, e.g., approximately eight or ten supported video-related protocols.

The classification algorithm of the autonomous classifier 150 identifies and utilizes flows, e.g., transmission flows, traffic flows, or communication flows. A flow may be defined in conjunction with TCP communication and/or UDP communication. A flow is characterized by port and address pair, for example, by a source port and address pair and/or by a destination port and address pair. In TCP communication, a flow may be similar to a connection. In some embodiments, the classification protocol of the autonomous classifier 150 determines that a flow exists only if a sufficient number of packets (namely, more than a pre-defined minimum threshold) have common or substantially identical characteristic(s), e.g., if three or more packets have common or substantially identical characteristic(s).

In some embodiments, the application protocol classifier 156 is not applied to each communicated packet. For example, the processing-intensive application protocol classifier 156 is not applied to packets which can be classified by the dynamically configurable port and address classifier 157; whereas the processing-intensive application protocol classifier 156 is applied to packets which cannot be classified by the dynamically configurable port and address classifier 157. In some embodiments, for example, the second-tier dynamically configurable port and address classifier 157 operates in the data path context, whereas the first-tier application protocol classifier 156 operates in another context (ergo, a parallel context having a lower priority), thereby avoiding “starvation” of the data path (namely, scarcity or lack of processing resources to handle the data path).

The application protocol classifier 156 is selectively applied substantially exclusively to flows that include sufficient data. Accordingly, the autonomous classifier 150 filters-out or disregards (e.g., does not classify) short sequences of packets which may overload the application protocol classifier 156; whereas audio/video streams carrying actual audio/video content are substantially always classified.

The classification algorithm of the autonomous classifier 150 identifies one or more application protocols patterns or signatures which characterize substantially each application protocol. A pattern includes a mask (namely, an array of address offsets and corresponding values) that matches a particular application layer protocol, e.g., typically indicating the protocol header. Optionally, a pattern may span multiple packets, for example, if the header includes one or more dynamic fields (e.g., sequence number of a time-stamp).

The classification algorithm of the autonomous classifier 150 may be implemented, for example, using the following demonstrative pseudo-code, denoted Code 1:

Code 1

01: FUNCTION MAIN_CLASSIFIER (PACKET)
02: IF NOT TCP AND NOT UDP
03: RETURN BEST_EFFORT
04: ELSE
05: IF CLASSIFIED_FLOW(PACKET)
06: PRIORITY = PORT_ADDR_CLASSIFIER(PACKET)
07: RETURN PRIORITY
08: ELSE
09: SEND_TO_PROTOCOL_CLASSIFIER(PACKET)
10: RETURN BEST_EFFORT
11: END IF
12: END IF

The function MAIN_CLASSIFIER( ) is called or otherwise executed substantially for each transmitted packet. As indicated in lines 2-3 of Code 1, the function MAIN_CLASSIFIER n is able to classify TCP and/or UDP packets; other packets are not classified, or are classified as “best effort”. As indicated in lines 5-7, the function MAIN_CLASSIFIER( ) is able to classify (e.g., substantially exclusively) packets that belong to CLASSIFIED_FLOW database or array, namely, packets for which the dynamically configurable port and address classifier 157 is able to determine the relevant priority. In contrast, packets that do not belong to the CLASSIFIED_FLOW database or array are sent to the application protocol classifier 156, as indicated at line 9.

The classification algorithm of the autonomous classifier 150 may define and utilize a FLOW structure, for example, in accordance with the following demonstrative pseudo-code, denoted Code 2:

Code 2

01: STRUCT FLOW
02: PORT
03: ADDRESS
04: TYPE: SOURCE OR DESTINATION
05: PACKET_COUNT
06: RECENT_PACKETS [MAX_PACKETS]

As indicated in Code 2, the FLOW structure includes, for example, port value, address value, type of the port and address pair (namely, whether the pair is a source pair or a destination pair), packet count (ergo, indicating the packets associated so far with the current flow), and an array of packets or recent packets associated with the current flow (e.g., up to a maximum threshold value). Other and/or additional parameters or fields may be used.

In some embodiments, the function MAIN_CLASSIFIER( ) and/or the function PORT_ADDR_CLASSIFIER( ) are executed in the transmission context, thereby allowing rapid performance. In contrast, the function PROTOCOL_CLASSIFIER( ) is executed in a different context, having a lower priority than the priority of the transmission context. Since the direct results of the function PROTOCOL_CLASSIFIER( ) are not used by the function MAIN_CLASSIFIER( ), the call to SEND_TO_PROTOCOL_CLASSIFIER( ) does not block the execution.

The function PROTOCOL_CLASSIFIER ( ), which is called in line 9 of Code 1, operates on multiple arrays or types of flows. This provides a protection mechanism, such that many short-lived connections do not overflow the application protocol classifier 156, whereas important audio/video streams are processed by the application protocol classifier 156 and are not skipped. A first array of flow is CLASSIFIED_FLOW, which is a database that includes flows that were already classified by the application protocol classifier 156 and are available to be used by the dynamically configurable port and address classifier 157. A second array of flow is ACTIVE_FLOW, which is a database that includes one or more flows for which a minimum amount of packets passed already (e.g., more than a pre-defined minimum threshold); packets from the ACTIVE_FLOW database are intended to be classified by the application protocol classifier 156, or are being classified by the application protocol classifier 156, and are candidates to enter the CLASSIFIED_FLOW database. A third array of flow is CANDIDATE_FLOW, which is a database that includes substantially all other flows, having one or more packets per flow, Packets belonging to the CANDIDATE_FLOW database are counted but are not classified by the application protocol classifier 156. When a flow from the CANDIDATE_FLOW database exceeds a pre-defined number of packets (denoted TRAFFIC_THRESHOLD), the flow is moved from the CANDIDATE_FLOW database to the ACTIVE_FLOW database for classification by the application protocol classifier 156.

The value of TRAFFIC_THRESHOLD may be determined or pre-defined, for example, based on the particular implementation; the threshold value may be, for example, three packets, six packets, eight packets, or other suitable values. In some embodiments, the TRAFFIC_THRESHOLD may have different values associated with different types of communications. For example, the TRAFFIC_THRESHOLD may have a first value with respect to UDP communications, and a second (e.g., greater) value with respect to TCP communications (e.g., because TCP application protocol classification consumes more processing resources than UDP application protocol classification).

In some embodiments, other and/or additional arrays of flows may be used. For example, optionally, a FAILED_FLOW array of flows may include a database of flows that encountered an error, e.g., a transmission error, a classification error, or the like. In some embodiments, for example, packets that belong to FAILED_FLOW are not processed (e.g., never) by the application protocol classifier 156.

The function PROTOCOL_CLASSIFIER( ), which is called in line 9 of Code 1, may be implemented, for example, using the following demonstrative pseudo-code, denoted Code 3;

Code 3

```
01: FUNCTION PROTOCOL_CLASSIFIER (PACKET)
02: IF NOT ACTIVE_FLOW (PACKET)
03:  FLOW_DETECTOR (PACKET)
04:  RETURN
05: END IF
06: FOR EACH PATTERN IN PROTOCOL_PATTERNS
07:  IF UDP (PACKET)
08:  IF MATCH (PACKET, PATTERN,
      ACTIVE_FLOW[PACKET])
09:  CLASSIFIED_FLOW[PACKET] <-
        ACTIVE_FLOW[PACKET]
10:  RETURN
11:  END IF
12:  ELSE // TCP
13:  FOR N=1, LENGTH (PACKET)
14:  IF MATCH (PACKET+N, PATTERN,
        ACTIVE_FLOW[PACKET])
15:  CLASSIFIED_FLOW[PACKET] <-
          ACTIVE_FLOW[PACKET]
16:  RETURN
17:  END IF
18:  END FOR
19:  END IF
20: END FOR
```

As indicated in lines 1-5 of Code 3, the function PROTOCOL_CLASSIFIER (operates on a packet that belongs to the ACTIVE_FLOW (e.g., a currently-examined packet) Packets that do not belong to the ACTIVE_FLOW are sent to the FLOW_DETECTOR( ) function, which is described herein with reference to Code 4. Referring again to Code 3, the function PROTOCOL_CLASSIFIER( ) checks whether the currently-examined packet matches a pattern from pre-defined patterns of application level protocols, for example, as indicated in the FOR loop of lines 6 and 20.

For each of the application level protocol patterns, the examination is different for UDP packets (lines 7-11) and TCP packets (lines 12-19). The algorithm checks whether or not there is a match among the currently-examined packet, the currently-examined pattern, and the ACTIVE_FLOW to which the currently-examined packet belongs. With regard to a UP packet (lines 7-11), the algorithm searches for, patterns at the specified location (e.g., offset) inside the UDP packet. With regard to a TCP packet (lines 12-19), the algorithm searches for patterns at substantially all possible locations inside the packet. In both cases, if there is a match (lines 9 and 15), then the ACTIVE_FLOW to which the currently examined-packet belongs is moved from the ACTIVE_FLOW database to the CLASSIFIED_FLOW database.

The function FLOW_DETECTOR( ), which is called in line 3 of Code 3, may be implemented, for example, using the following demonstrative pseudo-code, denoted Code 4:

Code 4

```
01: FUNCTION FLOW_DETECTOR (PACKET)
02: CANDIDATE_FLOW[PACKET] -> COUNT++
03: IF UDP (PACKET) AND
04:  CANDIDATE_FLOW[PACKET] -> COUNT>
      THRESHOLD[UDP]
05:  OR TCP (PACKET) AND
06:  CANDIDATE_FLOW[PACKET] -> COUNT>
      THRESHOLD[TCP]
07:  ACTIVE_FLOW[PACKET] <- CANDIDATE_FLOW[PACKET]
09: END IF
```

The function FLOW_DETECTOR of Code 4 operates to count packets and to move a flow from the CANDIDATE_FLOW database to the ACTIVE_FLOW database. The number of packets in the CANDIDATE_FLOW is tracked and updated (namely, increased) using a counter (line 2). If the currently-examined packet is a UDP packet, and the number of packets in the CANDIDATE_FLOW is larger than the minimum threshold value for determination of a UDP flow, then the CANDIDATE_FLOW to which the currently-examined packet belongs is moved from the CANDIDATE_FLOW database to the ACTIVE_FLOW database (lines 3-4 and 7). Alternatively, if the currently-examined packet is a TCP packet, and the number of packets in the CANDIDATE_FLOW is larger than the minimum threshold value for determination of a TCP flow, then the CANDIDATE_FLOW to which the currently-examined packet belongs is moved from the CANDIDATE_FLOW database to the ACTIVE_FLOW database (lines 5-7).

Optionally, other suitable functions may be used by the classification algorithm. For example, a FLOW_MAINTENANCE( ) function is executed (egg, periodically, at pre-defined time intervals, when a pre-defined number of packets were examined or classified, or the like) to remove flows from the databases (namely, from the ACTIVE_FLOW database, the CLASSIFIED_FLOW database, and the CANDIDATE_FLOW database) if one or more conditions or criteria are met. For example, a flow is removed from the relevant flow database if substantially no packets were added to that flow within a pre-defined timeout period. Optionally, different timeout periods may be set for different types of flows.

The classification algorithm utilizes multiple patterns that characterize the supported (namely, identifiable) application protocols. Patterns may be identified and added, for example, based on an analysis of traffic generated by the VideoLAN application running in different modes (e.g., utilizing different protocols), optionally using a packet “sniffer” or a protocol analyzer (e.g., Ethereal).

The classification algorithm is able to identify RTP frames, packets and/or flows. For example, a RTP flame or packet typically has the following header structure: a two-bit parameter (denoted V or Ver.) representing the version number of the protocol; a one-bit parameter (denoted P) representing padding, such that the bit is set if extra padding bytes are included at the end of the RTP packet; a one-bit parameter (denoted X) representing extension, such that the bit is set if extensions to the RTP protocol are used in the packet (and in such case, the header is followed by header extension); a four-bit parameter (denoted CC, or CSRC Count) representing the number of Contributing Source (CSRC) identifiers in the header; a one-bit parameter (denoted M) representing a marker, e.g., a profile-specific or application-specific marker; a seven-bit parameter (denoted PT) representing payload type; a sixteen-bit field representing the packet sequence number, incremented by one for each RTP packet; a 32-bit field representing a timestamp, e.g., the sampling instant of the first byte in the RTP data packet; a 32-bit field representing a Synchronization Source (SSRC) identifiers e.g., a unique number per RTP session; and a 32-bit field representing Contributing Source (CSRC) identifiers, egg, identifying the contributing sources for the payload contained in the RTP packet.

With regard to RTP packets, the classification algorithm is able to match, for example: Payload Type (PT) having a value of 32 (denoted MPV), representing MPEG-1 and MPEG-2 elementary stream; and Payload Type (PT) having a value of 33 (denoted MP2T), representing MPEG-2 Transport Stream (TS). A pattern that matches RTP with MPEG payload (e.g., with reliable probability) requires, for example, identification of three consecutive packets according to the following cumulative criteria: in each of the three packets, the value of the Version parameter (V) is two; in each of the three packets, the value of the Payload Type (PT) parameter is 32 or 33; the sequence number of the second packet is larger-by-one or larger-by-two than the sequence number of the first packet; the sequence number of the third packet is larger-by-one or larger-by-two than the sequence number of the second packet; the timestamp of the second packet is larger (or later) than the timestamp of the first packet; and the timestamp of the third packet is larger (or later) than the timestamp of the second packet.

The classification algorithm is able to identify MPEG Transport Stream (TS) frames, packets and/or flows. For example, a MPEG TS frame or packet typically has the following header structure: an eight-bit synchronization field (denoted Sync) having a value of 0x47; a one-bit flag representing Transport Error Indicator (denoted TEI or Terror); a one-bit flag representing a payload unit start indicator; a one-bit flag representing transport priority; a thirteen-bit field (denoted PID) representing packet identifier; a two-bit parameter (denoted TSC) representing transport scrambling control; a two-bit parameter (denoted AFC) representing adaptation field control; and a four-bit parameter (denoted Cont) representing a continuity counter, e.g., incremented at each consecutive packet that belongs to the same PID.

A packet of MPEG TS is either 188 bytes long or 204 bytes long. Accordingly, the classification algorithm may check both offsets for characterizing information, such that both 188-bytes packet length and 204-bytes packet length are checked and identified. For example, a MPEG TS packet, frame or flow is identified according to the following cumulative criteria: at the base packet (namely, offset zero), the Sync value is 0x47; in the second packet (namely, at offset 1, which may be 188 or 204 bytes, and both alternatives are checked), the Sync value is 0x47, and the Continuity value is larger-by-one than the continuity value of the first packet; in the third packet (namely, starting at offset 2, which may be at additional 188 or 204 bytes, and both alternatives are checked), the Sync value is 0x47, and the Continuity value is larger-by-one than the continuity value of the second packet; and in the fourth packet (namely, starting at offset 3, which may be 188 or 204 bytes, and both alternatives are checked), the Sync value is 0x47, and the Continuity value is larger-by-one than the continuity value of the third packet. For example, a single UDP packet may be sufficient to identify a pattern that matches MPEG TS, since a single UDP packet may encapsulate multiple MPEG TS packets.

The classification algorithm is able to identify stream audio/video produced by the VideoLAN as raw UDP. For example, the raw UDP output of the VideoLAN application utilizes MPEG TS encapsulated into UDP packets.

The classification algorithm is able to identify MMS audio/video packet, including, for example, to identify MMS command packet and/or MMS media packet. The MMS command packet is used by a client and a server for initial handshake, negotiation and metadata transfer. The MMS command packet header can be identified based on the following structure or partial-structure: a four-byte field having a value of 0xCEFA0BB0; a four-byte field representing the length of the MMS command; a four-byte field having a value of 0x4D4D5320 (which represents “MMS” in ASCII); a four-byte field indicating a sequence number (e.g., typically incremented for each command; a command response has the sequence number of the corresponding command request); an eight-byte field representing timestamp; and a four-byte field representing a command (optionally, including two bytes representing a command value, followed by two bytes representing message direction, i.e., client message or server message).

The MMS media packet encapsulates a video flame, typically sent in ASF format. The MMS media packet header can be identified based on the following structure or partial-structure: a four-byte field representing a sequence number (e.g., typically incremented for each packet); a one-byte packet ID or session number (e.g., incremented for each play/stop action by the media player); a one-byte field (denoted Flags) representing one or more transport protocol flags, e.g., TCP flags, UDP sequence (incremented by one for each UDP packet); and a two-bytes field (denoted Len or Length) representing the packet length.

In some embodiments, optionally, the classification algorithm may search for MMS media packets and may not search for MMS command packets. The classification algorithm may identify MMS media packets according to the following cumulative criteria: three consecutive packets are matched in order to identify MMS packets with a reliable probability; the Flags field and the Length field are checked only in UDP transport (and are not checked in TCP transport); the sequence number of the second packet is equal to the sequence number of the first packet, or is larger-by-one than the sequence number of the first packet; the sequence number of the third packet is equal to the sequence number of the second packet, or is larger-by-one than the sequence number of the second packet; the packet ID number of the second packet is equal to the packet ID number of the first packet, or is larger-by-one than the packet ID number of the first packet; the packet ID number of the third packet is equal to the packet ID number of the second packet, or is larger-by-one than the packet ID number of the second packet; in UDP transport, the Flags field value of the second packet is equal to the Flags field value of the first packet, or is larger-by-one than the Flags field value of the first packet; the Flags field value of the third packet is equal to the Flags field value of the second packet, or is larger-by-one than the Flags field value of the second packet; and in UDP transport, the first packet, the second packet and the third packet have the same Length field value.

Although portions of the discussion herein relate, for demonstrative purposes, to classification or identification based on three consecutive packets, other number of packets may be used for identification or classification, for example, one packet, two packets, four packets, five packets, other number of packets, a series of consecutive packets, a series of non-consecutive packets, a series that includes a portion having consecutive packets and a portion have non-consecutive packets, or the like. In some embodiments, as a result of setting a minimum number of packets required for classification (e.g., three consecutive packets), one or more initial packets may be non-classified (e.g., handled and transmitted as “best effort), whereas subsequent packets of that flow may be classified with reasonable reliability or with high reliability.

The classification algorithm is autonomous, since it does not require manual configuration or modification or set-up. In some embodiments, the classification algorithm may be manually extended or modified in order to support new protocols and/or audio/video applications, for example, which may use slightly different or non-standard structure or protocols to distribute audio/video.

In some embodiments, in addition to the dynamically-configurable port and address classifier 157 (which is configured based on the configuration information 158 generated by the application protocol classifier 156), the autonomous classifier 150 may optionally include a static port and address classifier 161, which may be configurable or set-up manually by a user, e.g., if there exists a-priori information of audio/video (or other application level protocol) port and address. Accordingly, the autonomous classifier 150 may perform classification taking into account results generated by the static port and address classifier 161.

Some embodiments may perform other and/or additional operations, to meet requirements of specific implementations and/or to further optimize the traffic classification. For example, some embodiments may take into account RTP payload type in the classification process, whereas other embodiments may ignore the RTP payload type in the classification process. Some embodiments may classify both UDP and TCP communications, whereas other embodiments may support only non-TCP communications. In some embodiments, instead of or in addition to identifying or matching three (or other number of) MMS packets, one (or more) ASF header(s) may be identified or matched. Some embodiments may handle or otherwise ensure correct re-ordering of packets, for example, when a video stream is classified and switched from “best effort” service to “video” service. Some embodiments may handle admission-controlled video, for example, to disable or bypass the autonomous classifier 150 if there is no admission for video. Some embodiments may handle “aging”, for example, by performing re-classification (of packets or frames) after a pre-defined time period, at pre-defined time intervals, when one or more conditions are met, or the like.

In some embodiments, the autonomous classifier 150 may be implemented using hardware components, software components, or a combination of hardware and software components. For example, in some embodiments utilizing UNIX or Linux operating systems, the autonomous classifier 150 may be implemented as a separate kernel module, and a driver manager may determine whether or not to load such autonomous classifier module; for example, the autonomous classifier module may be loaded after the driver module is loaded, and before configuration. When loaded, the autonomous classifier module may register a callback in the driver, which is called for substantially each packet. The callback may be defined, for example, as follows: PRIORITY AUTONOMOUS_CLASSIFER (VOID*PACKET)

The callback may classify the packet using port and address classifier (if possible), and return substantially immediately or rapidly, such that the returned priority is either “best effort” or the priority determined based on port and address classification. The PRIORITY function may not perform intensive processing operation (namely, application protocol classification), but rather may wake a kernel thread to perform application protocol classification. Accordingly, the processing-intensive operations (namely, the application protocol classification) are performed in a work queue running in the context of low priority kernel thread.

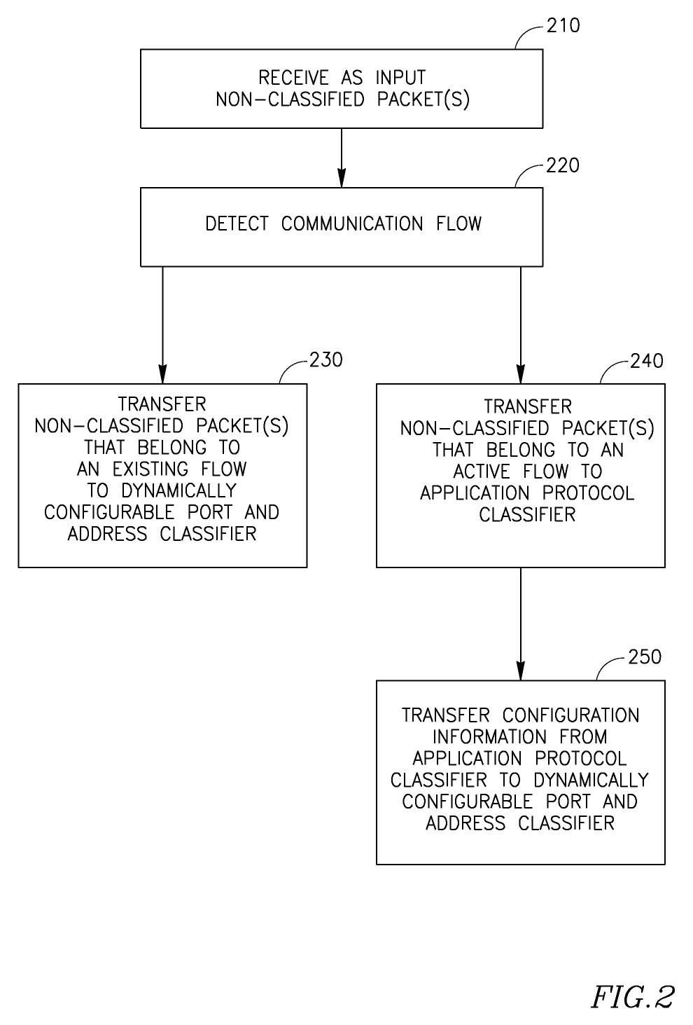

FIG. 2 is a schematic flow-chart of a method of classification of communication traffic in accordance with some demonstrative embodiments of the invention, Operations of the method may be used, for example, by system 100 of FIG. 1, by transmitting device 110 of FIG. 1, by the autonomous classifier 150 of FIG. 1, and/or by other suitable units, devices and/or systems.

In some embodiments, the method may include, for example, receiving as input one or more non-classified packet(s) intended for classification (e.g., packets intended for transmission) (block 210). The method may include, for example, detecting or characterizing a communication flow to which the non-classified packet(s) belong (block 220).

Non-classified packets that belong to an existing communication flow (e.g., a classified flow) are transferred to a dynamically configurable port and address classifier for classification (block 230). Alternatively, non-classified packets that belong to a communication flow that was not yet classified (e.g., a non-classified flow, or an active flow), are transferred to an application protocol classifier, (lock 240). Information generated by the application protocol classifier (e.g., a port and address pair) is transferred as configuration information to the dynamically configurable port and address classifier (block 250).

Other suitable operations or sets of operations may be used in accordance with embodiments of the invention. In some embodiments, operations may be performed in other order of execution, substantially in parallel, in a sequence, or the like. In some embodiments, one or more operations may be repeated and/or re-performed, for example, for a pre-defined number of iterations, at pre-defined time intervals, or when one or more conditions are met.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or, computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, and an optical disk. Some demonstrative examples of optical disks include Compact Disk-Read Only Memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A communication traffic classifier comprising:
a dynamically configurable port and address classifier to classify an unclassified packet based on port and address configuration information received from an application protocol classifier.

2. The communication traffic classifier of claim 1, further comprising said application protocol classifier, wherein the application protocol classifier is to generate the port and address information based on an application layer pattern analysis of one or more other unclassified packets.

3. The communication traffic classifier of claim 2, further comprising:
a flow detector to receive the unclassified packet, to send the unclassified packet to the dynamically configurable port and address classifier if the unclassified packet belongs to a previously-classified communication flow, and to send the unclassified packet to the application protocol classifier if the unclassified packet belongs to a unclassified communication flow.

4. The communication traffic classifier of claim 3, wherein the flow detector is to determine that a communication flow belongs to either:
a group of one or more previously-classified communication flows; or
a group of one or more active communication flows that include packets intended for classification by the application protocol classifier.

5. The communication traffic classifier of claim 4, wherein the flow detector is to add a candidate communication flow to the group of one or more active communication flows if the number of packets in a candidate communication flow is larger than a value of a pre-defined threshold parameter.

6. The communication traffic classifier of claim 5, wherein the pre-defined threshold parameter has a first value with respect to UDP communication, and a second, larger, value with respect to TCP communication.

7. The communication traffic classifier of claim 2, wherein the application protocol classifier is to determine whether or not there exists a match between packets belonging to an unclassified communication flow, and a pre-defined pattern of application level protocol.

8. The communication traffic classifier of claim 7, wherein if the application protocol classifier determines that the match exists, then the application protocol classifier is to move the unclassified communication flow from a database of unclassified communication flows to a database of classified communication flows.

9. The communication traffic classifier of claim 2, wherein the application protocol classifier is to classify the unclassified packet based on an analysis of a header of at least one more unclassified packet.

10. The communication traffic classifier of claim 9, wherein the application protocol classifier is to determine whether the unclassified packet is a Real-time Transport Protocol (RTP) packet by taking into account at least a protocol version parameter, a payload type parameter, a sequence number parameter, and a timestamp parameter.

11. The communication traffic classifier of claim 9, wherein the application protocol classifier is to determine whether the unclassified packet is a MPEG Transport Stream (TS) packet by taking into account at least a value of a synchronization parameter and a value of a continuity parameter.

12. The communication traffic classifier of claim 9, wherein the application protocol classifier is to determine whether the unclassified packet is a Microsoft Media Server (MMS) packet by taking into account at least a value of a sequence number field and a value of a packet ID field.

13. The communication traffic classifier of claim 12 wherein, if the packet is a UDP packet, the application protocol classifier further takes into account at least a value of a flags field and a value of a length field.

14. The communication traffic classifier of claim 2, wherein the dynamically configurable port and address classifier runs in a first thread, and wherein the application protocol classifier runs in a second, lower-priority, thread.

15. An apparatus comprising the communication traffic classifier of claim 1, wherein the apparatus comprises a device selected from a group consisting of: a mobile computer, a desktop computer, a wireless access point, a router, and a set-top box.

16. A method of classifying communication traffic, the method comprising:
classifying an unclassified packet based on port and address configuration information received by a dynamically configurable port and address classifier from an application protocol classifier.

17. The method of claim 16, further comprising:
generating the port and address information based on an application layer pattern analysis of one or more other unclassified packets.

18. The method of claim 17, further comprising:
sending the unclassified packet to the dynamically configurable port and address classifier if the unclassified packet belongs to a previously-classified communication flow, and
sending the unclassified packet to the application protocol classifier if the unclassified packet belongs to an unclassified communication flow.

19. The method of claim 18, comprising:
determining that a communication flow belongs to either:
a group of one or more previously-classified communication flows; or,
a group of one or more active communication flows that include packets intended for classification by the application protocol classifier.

20. The method of claim 19, comprising:
adding a candidate communication flow to the group of one or more active communication flows if the number of packets in a candidate communication flow is larger than a value of a pre-defined threshold parameter.

21. The method of claim 20, wherein the pre-defined threshold parameter has a first value with respect to UDP communication, and a second, larger, value with respect to TCP communication.

22. The method of claim 17, comprising:
determining whether or not there exists a match between packets belonging to an unclassified communication flow, and a pre-defined pattern of application level protocol.

23. The method of claim 22, comprising:
if it is determined that the match exists, moving the unclassified communication flow from a database of unclassified communication flows to a database of classified communication flows.

24. The method of claim 17, comprising:
classifying the unclassified packet based on an analysis of a header of at least one more unclassified packet.

25. The method of claim 24, comprising:
determining whether the unclassified packet is a Real-time Transport Protocol (RTP) packet by taking into account at least a protocol version parameter, a payload type parameter, a sequence number parameter, and a timestamp parameters.

26. The method of claim 24, comprising:
determining whether the unclassified packet is a MPEG Transport Stream (TS) packet by taking into account at least a value of a synchronization parameter and a value of a continuity parameter.

27. The method of claim 9, comprising:
determining whether the unclassified packet is a Microsoft Media Server (MMS) packet by taking into account at least a value of a sequence number field and a value of a packet ID field.

28. The method of claim 27, comprising:
if the packet is a UDP packet, further taking into account at least a value of a flags field and a value of a length field.

29. The method of claim 17, comprising:
running the dynamically configurable port and address classifier in a first thread; and
running the application protocol classifier in a second, lower-priority, thread.
